(19) United States
(12) Patent Application Publication
(10) Pub. No.: US 2026/0019097 A1
(43) Pub. Date: Jan. 15, 2026

(54) RADIO TRANSCEIVER SYSTEM

(71) Applicant: Nokia Technologies Oy, Espoo (FI)

(72) Inventors: Christian ROM, Aalborg (DK); Feridoon JALILI, Aalborg (DK)

(21) Appl. No.: 19/257,815

(22) Filed: Jul. 2, 2025

(30) Foreign Application Priority Data
Jul. 12, 2024 (GB) 2410165.1

(51) Int. Cl. H04B 1/04; H04B 1/40

(52) U.S. Cl. CPC H04B 1/0483; H04B 1/40

(57) ABSTRACT

A system comprising: a transceiver module comprising transceiver circuitry; antenna modules providing antennas; interconnects, between the transceiver module and antenna modules, completing communication paths between the transceiver circuitry and each antenna; phase control and amplification circuitry associated with the communication paths, wherein, for a first sub-set of the communication paths, the phase control and amplification circuitry is located in antenna modules and, for a second, different, sub-set of the communication paths, the phase control and amplification circuitry is located in the transceiver module.

### TECHNOLOGICAL FIELD

Examples of the disclosure relate to a radio transceiver system. Some relate to a radio transceiver system for a user equipment.

### BACKGROUND

It is desirable to produce apparatus that have high levels of performance without a correspondingly high bill of materials. In radio communications, the bill of materials can be reduced by using cheaper, for example passive, components and by centralizing the more expensive active circuitry. However, this can significantly degrade performance particularly at higher frequencies because of signal attenuation.

### BRIEF SUMMARY

According to various, but not necessarily all, examples there is provided a transceiver module comprising: transceiver circuitry; ports for coupling to antennas; transceiver paths extending between the transceiver circuitry and the ports, wherein a first sub-set of the transceiver paths are associated with a first sub-set of the ports and a second sub-set of the transceiver paths are associated with a second sub-set of the ports, wherein the transceiver paths or paths of the second sub-set of the transceiver paths are different compared to the transceiver path or paths of the first sub-set of the transceiver paths because phase control and amplification circuitry, that is present in the transceiver path or paths of the second sub-set of transceiver paths is absent from the transceiver path or paths of the first sub-set of transceiver paths.

In some, but not necessarily all examples, the transceiver module comprises antenna module interfaces for coupling to respective antenna modules, each antenna module interface comprising at least one port for coupling to an antenna.

In some, but not necessarily all examples, each antenna module interface comprises at least one port of the first sub-set for coupling to an antenna and at least one port of the second sub-set for coupling to an antenna.

In some, but not necessarily all examples, each antenna module interface comprises the same number of ports and the same number of ports belonging to the first sub-set of ports and the same number of ports belonging to the second sub-set of ports.

In some, but not necessarily all examples, a transceiver path is shared by multiple ports.

In some, but not necessarily all examples, the multiple ports sharing the transceiver path are in different antenna module interfaces of the transceiver module.

In some, but not necessarily all examples, switching circuitry is configured to share a transceiver path with one port in each antenna module interface of the transceiver module.

In some, but not necessarily all examples, each transceiver path has switching circuitry configured to share the transceiver path with one port in each antenna module interface of the transceiver module.

In some, but not necessarily all examples, the switching circuitry in a transceiver path of the first sub-set of transceiver paths is configured to switch the transceiver path to one of multiple ports.

In some, but not necessarily all examples, the switching circuitry in a transceiver path of the second sub-set of transceiver paths is configured to share the transceiver path with only one port at a time.

According to various, but not necessarily all, examples there is provided an antenna module comprising: multiple antennas; multiple antenna ports, each associated with an antenna; a communication path between each respective antenna port and an antenna; wherein a first sub-set of the communication paths is associated with a first sub-set of antenna ports and a second sub-set of the communication paths is associated with a second sub-set of the antenna ports, wherein the communication path or paths in the first sub-set of the communication paths are different than the communication path or paths in the second sub-set of the communication paths because phase control and amplification circuitry that is present in the communication path or paths of the first sub-set of communication paths is absent from the communication path or paths of the second sub-set of communication paths

In some, but not necessarily all examples, the first sub-set of the communication paths includes only one communication path and the second sub-set of the communication paths includes multiple communication paths.

In some, but not necessarily all examples, each communication path in the first sub-set of the communication paths enables an active antenna and each communication path in the second sub-set of the communication paths enables a passive antenna.

According to various, but not necessarily all, examples there is provided a system comprising:
a transceiver module comprising transceiver circuitry;
antenna modules providing antennas;
interconnects, between the transceiver module and antenna modules, completing communication paths between the transceiver circuitry and each antenna;
phase control and amplification circuitry associated with the communication paths, wherein, for a first sub-set of the communication paths, the phase control and amplification circuitry is located in antenna modules and, for a second, different, sub-set of the communication paths, the phase control and amplification circuitry is located in the transceiver module.

In some, but not necessarily all examples, each antenna module comprises a transceiver module interface for interconnection with the transceiver module and wherein the transceiver module comprises an antenna module interface for each antenna module, for interconnection with the transceiver module interface of the antenna module.

In some, but not necessarily all examples, all transceiver module interfaces of the antenna modules have the same number and configuration of ports and all antenna module interfaces of the transceiver module have the same number and configuration of ports, and wherein the number and configuration of ports in the antenna module interfaces correspond with the number and configuration of ports in the transceiver module interface for one-to-one connection.

In some, but not necessarily all examples, the switching circuitry is configured to share each transceiver path with one port in each antenna module interface to an antenna module.

In some, but not necessarily all examples, the transceiver module comprises: transceiver paths extending between the transceiver circuitry and ports for coupling to antennas, wherein a first sub-set of the transceiver paths are associated with a first sub-set of the ports and a second sub-set of the transceiver paths are associated with a second sub-set of the ports, wherein the transceiver paths or paths of the second sub-set of the transceiver paths are different compared to the transceiver path or paths of the first sub-set of the transceiver paths because phase control and amplification circuitry, that is present in the transceiver path or paths of the second sub-set of transceiver paths is absent from the transceiver path or paths of the first sub-set of transceiver paths.

In some, but not necessarily all examples, switching circuitry in a transceiver path of the first sub-set of transceiver paths is configured to switch the transceiver path to one port of each antenna module interface to an antenna module and wherein the switching circuitry in a transceiver path of the second sub-set of transceiver paths is configured to switch the transceiver path to only one port at a time selected from one port in each antenna module interface.

In some, but not necessarily all examples, switching circuitry in a transceiver path of the first sub-set of transceiver paths is configured to share the transceiver path with the same numbered port in each antenna module interface, wherein a number of a port is a position of that port in a sequence of ports at an antenna module interface.

In some, but not necessarily all examples, each antenna module comprises:
multiple antenna ports, each associated with an antenna;
a communication path between each respective antenna port and an antenna;
wherein a first sub-set of the communication paths is associated with a first sub-set of antenna ports and a second sub-set of the communication paths is associated with a second sub-set of the antenna ports, wherein the communication path or paths in the first sub-set of the communication paths are different than the communication path or paths in the second sub-set of the communication paths because phase control and amplification circuitry that is present in the communication path or paths of the first sub-set of communication paths is absent from the communication path or paths of the second sub-set of communication paths.

While the above examples of the disclosure and optional features are described separately, it is to be understood that their provision in all possible combinations and permutations is contained within the disclosure. It is to be understood that various examples of the disclosure can comprise any or all the features described in respect of other examples of the disclosure, and vice versa. Also, it is to be appreciated that any one or more or all the features, in any combination, may be implemented by/comprised in/performable by an apparatus, a method, and/or computer program instructions as desired, and as appropriate. The description of a function should additionally be considered to also disclose any means suitable for performing that function.

### BRIEF DESCRIPTION

Some examples will now be described with reference to the accompanying drawings in which:

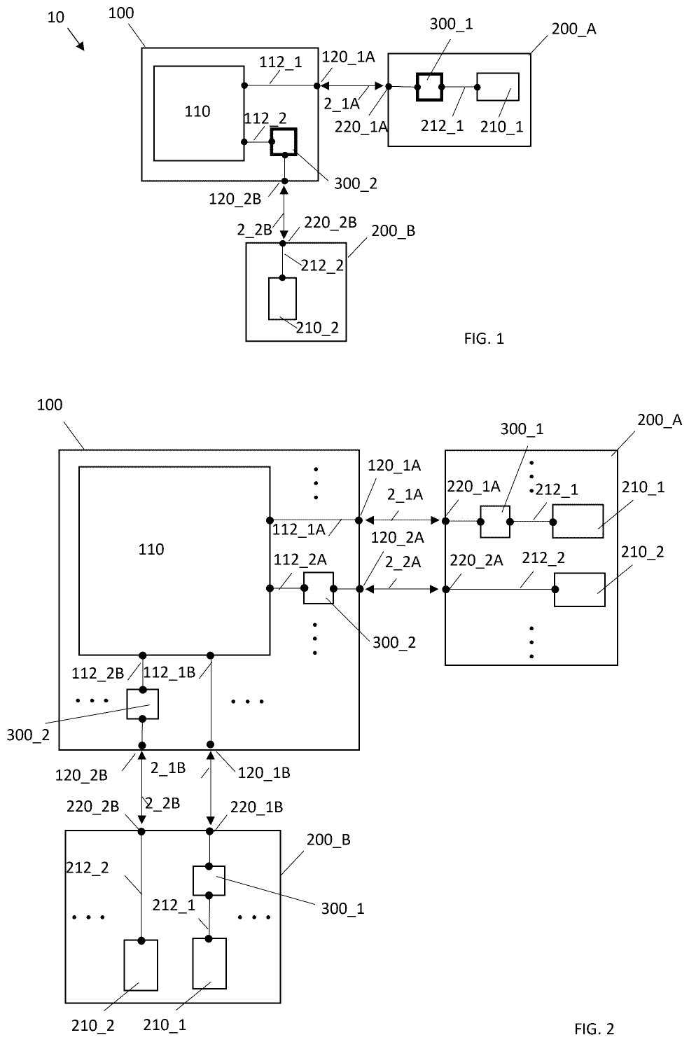

FIG. 1 shows an example of the subject matter described herein;

FIG. 2 shows another example of the subject matter described herein;

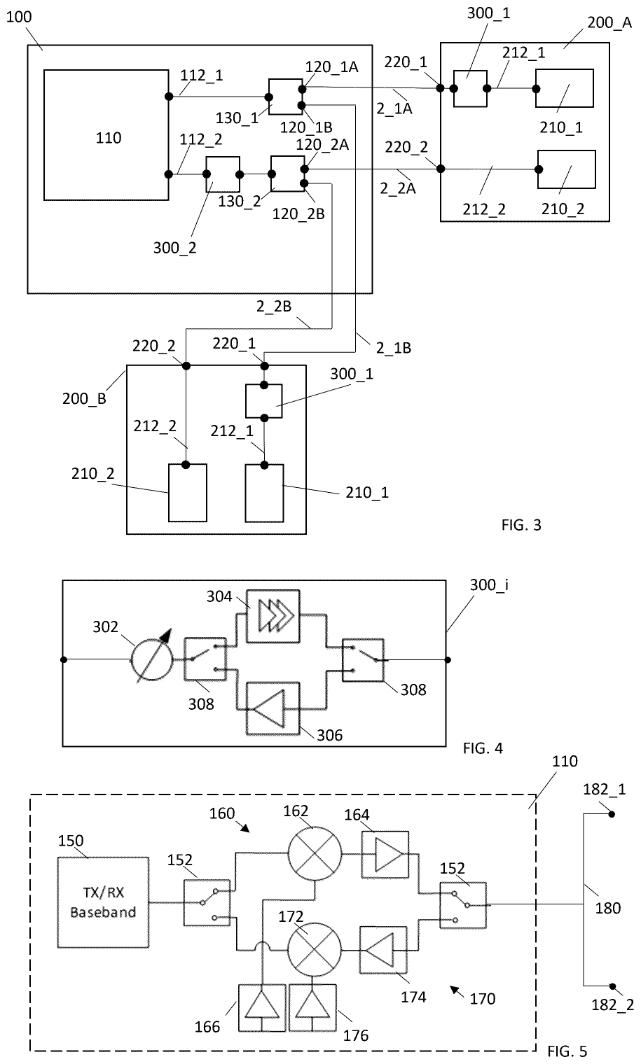

FIG. 3 shows another example of the subject matter described herein;

FIG. 4 shows another example of the subject matter described herein;

FIG. 5 shows another example of the subject matter described herein;

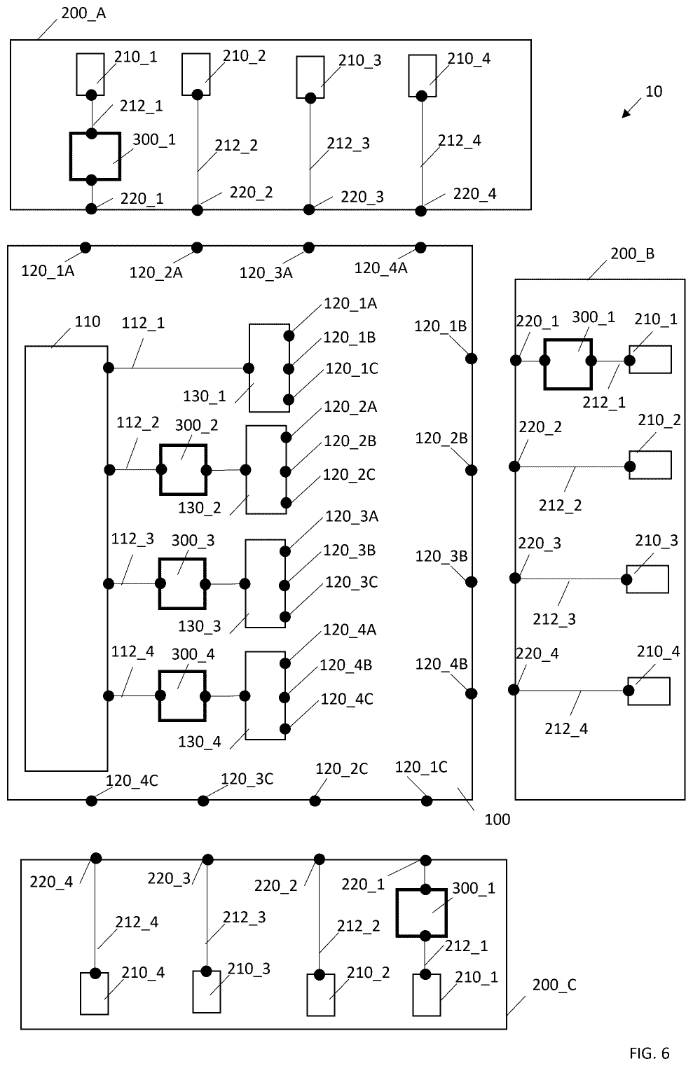

FIG. 6 shows another example of the subject matter described herein;

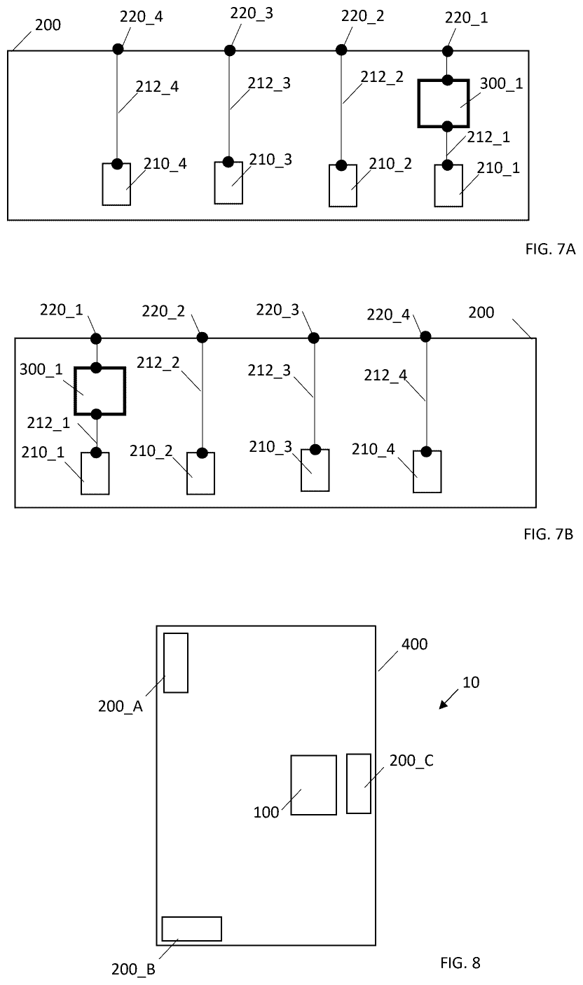

FIG. 7A shows another example of the subject matter described herein;

FIG. 7B shows another example of the subject matter described herein;

FIG. 8 shows another example of the subject matter described herein.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

In the following description a class can be referenced using a reference number without a subscript index (e.g. 112, 120, 220, 212, 210, 200) and a specific instance of the class can be referenced using the reference number with an alphanumerical type subscript index (e.g. 112_1, 120_1A, 220_1, 212_1, 210_1, 200_A) and a non-specific instance of the class can be referenced using the reference number with a variable type subscript index (e.g. 112_i, 120_ij, 220_i, 212_i, 210_i, 200_j)

### DETAILED DESCRIPTION

The FIGs illustrate an example of a system 10 comprising: a transceiver module 100 comprising transceiver circuitry 110; antenna modules 200 providing antennas 210; and interconnects 2, between the transceiver module 100 and the antenna modules 200, completing communication paths between the transceiver circuitry 110 and the antennas 210. The system 10 can, for example, be part of a larger apparatus, for example, an apparatus for radio communications. Examples include a mobile terminal (user equipment). The system 10 comprises phase control and amplification circuitry 300 associated with the communication paths. For a first sub-set of the communication paths, the phase control and amplification circuitry 300 is not located in the transceiver module 100 and is located in an antenna module 200. For a second, different, sub-set of the communication paths, the phase control and amplification circuitry 300 is located in the transceiver module 100 and not located in an antenna module 200.

In FIG. 1 a system 10 comprises: a transceiver module 100, multiple antenna modules 200, interconnects 2 between the transceiver module 100 and the antenna modules 200. The transceiver module 100 comprises transceiver circuitry 110. The antenna modules 200 provide antennas 210.

The interconnects 2, between the transceiver module 100 and the antenna modules 200, complete communication paths between the transceiver circuitry 110 and the antennas 210. An interconnect 2_1A, between the transceiver module 100 and the antenna module 200_A, completes a communication path between the transceiver circuitry 110 and the antenna 210_1. An interconnect 2_2B, between the transceiver module 100 and the antenna module 200_B, completes a communication path between the transceiver circuitry 110 and the antenna 210_2.

The system 10 comprises phase control and amplification circuitry 300_1 associated with a communication path to the antenna 210_1. The system 10 comprises phase control and amplification circuitry 300_2 associated with a communication path to the antenna 210_2.

A first sub-set of the communication paths, includes the communication path to the antenna 210_1. The phase control and amplification circuitry 300_1, for this communication path, is located in an antenna module (not located in the transceiver module 100). A second sub-set of the communication paths, includes the communication path to the antenna 210_2. The phase control and amplification circuitry 300_2, for this communication path, is located in the transceiver module 100 (not located in an antenna module 200).

There is a communication path between the transceiver circuitry 110 and each antenna 210. Each communication path between the transceiver circuitry 110 and an antenna 210_i has a portion in the transceiver module (the transceiver path 112_i), a portion via an interconnect 2-ij, and a portion 212_i in an antenna module 200_j.

In the following examples, an interconnect 2_i is used for one antenna 210_i and the communication path 212_i in an antenna module is used for one antenna 210_i. Each communication path is via a (transceiver) port 120_ij and an antenna port 220_i which are used for communication with one antenna 210_i in the antenna module 200_j.

In some examples, there is one transceiver path 112 in a transceiver module for each antenna (see FIGS. 1 & 2). In other examples, there is one transceiver path 112 in a transceiver module for multiple antennas in different antenna modules 200 (see FIG. 3, 6).

The transceiver module 100 comprises: transceiver circuitry 110; and transceiver paths 112 extending between the transceiver circuitry 110 and ports 120. A first sub-set of the transceiver paths 112 is associated with a first sub-set of the (transceiver) ports 120. A second sub-set of the transceiver paths 112 is associated with a second sub-set of the (transceiver) ports 120. The second sub-set of the transceiver paths are different compared to the first sub-set of the transceiver paths because phase control and amplification circuitry 300, that is present in the second sub-set of transceiver paths is absent from the first sub-set of transceiver paths.

In FIG. 1, the transceiver path 112_1 (first sub-set) is associated with the port 120_1A (first sub-set). The port 120_1A is port 1 for antenna module 200_A. The transceiver path 112_2 (second sub-set) is associated with the port 120_2B (second sub-set), The port 120_2B is port 2 for antenna module 200_B.

The transceiver path 112_1 (first sub-set), associated with the port 120_1A, does not comprise phase control and amplification circuitry 300_2. The phase control and amplification circuitry 300_1 for this communication path between transceiver circuitry 110 and the antenna 210_1 is in an antenna module (the antenna module 200_A,) not in the transceiver module 100. The transceiver path 112_2 (second sub-set), associated with the port 120_2B (second sub-set), does comprise phase control and amplification circuitry 300_2. The phase control and amplification circuitry 300_2 for this communication path between transceiver circuitry 110 and the antenna 210_2 is in the transceiver module 100, not an antenna module 200_A, 200_B.

There are two antenna modules 200_A, 200_B. The antenna modules 200, in combination, comprise: antenna ports 220, each associated with an antenna 210; and communication paths 212 between the antenna ports 220 and the associated antenna 210.

A first sub-set 212_1 of the communication paths 212 is associated with a first sub-set 120_1 of antenna ports 120 and a second sub-set 212_2 of the communication paths 212 is associated with a second sub-set 120_2 of antenna ports 120, where the first sub-set 212_1 of the communication paths is different than the second sub-set 212_2 of the communication paths because phase control and amplification circuitry 300_1 that is present in the first sub-set 212_1 of communication paths is absent from the second sub-set 212_2 of communication paths.

The antenna modules 200_A comprise an antenna port 220_1A, associated with the antenna 210_1. The communication path 212_1 extends between the antenna port 220_1A and the antenna 210_1.

The antenna modules 200_B comprise an antenna port 220_2B, associated with the antenna 210_2. The communication path 212_2 extends between the antenna port 220_2B and the antenna 210_2.

In FIG. 1, the communication path 212_1 (first sub-set) associated with antenna port 220_1A (first sub-set), comprises phase control and amplification circuitry 300_1. The phase control and amplification circuitry 300_1 for this communication path between transceiver circuitry 110 and the antenna 210_1 is in the antenna module 200_A, not the transceiver module 100.

The communication path 212_2 (second sub-set) associated with antenna port 220_2B (second sub-set) does not comprise phase control and amplification circuitry 300_2. The phase control and amplification circuitry 300_2 for this communication path between transceiver circuitry 110 and the antenna 210_2 is in the transceiver module 100, not an antenna module 200.

The transceiver module 110 has a port 120 for each antenna 210. Each transceiver path 112 is associated with one or more ports 120, and in this example each transceiver path 112 is associated with one port 120.

The transceiver module 110 comprises an antenna module interface for connection, via interconnects 2, to a transceiver module interface of the antenna module 200_A. The antenna module interface at the transceiver module 100 presents one or more ports 120 for connection to a transceiver module interface of one antenna module 200_A. The transceiver module interface at the antenna module presents one or more antenna ports 220 for connection to a corresponding antenna module interface of the transceiver module. An interconnect 2 connects a port 120 and an antenna port 220 in a one-to-one mapping.

The transceiver module 110 comprises an antenna module interface for connection, via interconnects 2, to a transceiver module interface of the antenna module 200_B. The antenna module interface at the transceiver module 100 presents one or more ports 120 for connection to a transceiver module interface of one antenna module 200_B. The transceiver module interface at the antenna module 200_B presents one or more antenna ports 220 for connection to a corresponding antenna module interface of the transceiver module. An interconnect 2 connects a port 120 and an antenna port 220 in a one-to-one mapping.

The antenna 210_1 of the antenna module 200_A can be described as an active antenna because the local on-antenna-module phase control and amplification circuitry 300_1 in its communication path 212_1 draws power.

The antenna 210_2 of the antenna module 200_B can be described as a passive antenna because the communication path 212_2 does not draw power because it has no local phase control and amplification circuitry 300_2.

The antenna module 200_B can be described as a passive antenna module it does not draw power because it has no local phase control and amplification circuitry 300_2.

It will be appreciated that there is a one-to-one mapping between antenna 210_i, communication path 212_i, antenna port 220_i, transceiver port 120_i. The mapping between transceiver path 112 and transceiver port 120 is one-to-one in this example.

As in FIG. 1, the system 10 in FIG. 2 comprises: a transceiver module 100, multiple antenna modules 200, interconnects 2 between the transceiver module 100 and the antenna modules 200. The transceiver module 100 comprises transceiver circuitry 110. The antenna modules 200 provide antennas 210.

The interconnects 2, between the transceiver module 100 and the antenna modules 200, complete communication paths between the transceiver circuitry 110 and the antennas 210. There is a communication path between the transceiver circuitry 110 and each antenna 210.

A first sub-set of the communication paths, includes the communication paths 212_1 to the antenna 210_1 in antenna module 200_A and in antenna module 200_B. The phase control and amplification circuitry 300_1, for these communication paths, are located in the respective antenna module 200_A, 200_B (not located in the transceiver module 100). A second sub-set of the communication paths, includes the communication path 212_2 to the antenna 210_2 in antenna module 200_A and in antenna module 200_B. The phase control and amplification circuitry 300_2, for these communication paths, are located in the transceiver module 100 (not located in antenna modules 200_A, 200_B).

The transceiver module 100 comprises: transceiver circuitry 110; and transceiver paths 112 extending between the transceiver circuitry 110 and ports 120.

A first sub-set of the transceiver paths 112 is associated with a first sub-set of the ports 120. A second sub-set of the transceiver paths 112 is associated with a second sub-set of the ports 120. The second sub-set of the transceiver paths are different compared to the first sub-set of the transceiver paths because phase control and amplification circuitry 300_2, that is present in the second sub-set of transceiver paths is absent from the first sub-set of transceiver paths.

In FIG. 2, the transceiver path 112_1A (first sub-set) is for the port 120_1A (first sub-set). The port 120_1A is port 1 for antenna module 200_A. The transceiver path 112_1A is the path to port 120_1A.

The transceiver path 112_1B (first sub-set) is associated with the port 120_1B (first sub-set). The port 120_1B is port 1 for antenna module 200_B. The transceiver path 112_1B is the path to port 120_1B.

The transceiver path 112_2A (second sub-set) is associated with the port 120_2A (second sub-set). The port 120_2A is port 2 for antenna module 200_A. The transceiver path 112_2A is the path to port 120_2A.

The transceiver path 112_2B (second sub-set) is associated with the port 120_2B (second sub-set). The port 120_2B is port 2 for antenna module 200_B. The transceiver path 112_2B is the path to port 120_2B.

The transceiver path 112_1A (first sub-set), associated with the port 120_1A, does not comprise phase control and amplification circuitry 300_1. The phase control and amplification circuitry 300_1 for this communication path between transceiver circuitry 110 and the antenna 210_1 of the antenna module 200_A is in an antenna module (the antenna module 200_A,) not in the transceiver module 100.

The transceiver path 112_2A (second sub-set), associated with the port 120_2A (second sub-set), does comprise phase control and amplification circuitry 300_2. The phase control and amplification circuitry 300_2 for this communication path between transceiver circuitry 110 and the antenna 210_2 of the antenna module 200_A is in the transceiver module 100, not the antenna module 200_A.

The transceiver path 112_1B (first sub-set), associated with the port 120_1B does not comprise phase control and amplification circuitry 300_1. The phase control and amplification circuitry 300_1 for this communication path between transceiver circuitry 110 and the antenna 210_1 of the antenna module 200_B is in an antenna module (the antenna module 200_B,) not in the transceiver module 100.

The transceiver path 112_2B (second sub-set), associated with the port 120_2B (second sub-set), does comprise phase control and amplification circuitry 300_2. The phase control and amplification circuitry 300_2 for this communication path between transceiver circuitry 110 and the antenna 210_2 of the antenna module 200_B is in the transceiver module 100, not the antenna module 200_B.

There are two antenna modules 200_A, 200_B.

The antenna module 200_A comprises: multiple antennas 210_i; multiple antenna ports 220_iA, each associated with an antenna 210_i; communication paths 212_i between antenna ports 220_iA and antennas 210_i comprising a first sub-set (212_1) of communication paths 212 associated with a first sub-set (220_1) of antenna ports 220, and a second sub-set (212_2) of communication paths 212 associated with a second sub-set (220_2) of antenna ports 220, wherein the communication path or paths 212_1 of the first sub-set of the communication paths 212 are different than the communication path or paths 212_2 of the second sub-set of the communication paths 212 because phase control and amplification circuitry 300_1 that is present in the communication path or paths 212_1 of the first sub-set of communication paths 212 is absent from the communication path or paths 212_2 of the second sub-set of communication paths 212.

The antenna module 200_B comprises: multiple antennas 210_i; multiple antenna ports 220_iB, each associated with an antenna 210_i; communication paths 212_i between antenna ports 220_iB and antennas 210_i comprising a first sub-set (212_1) of communication paths 212 associated with a first sub-set (220_1) of antenna ports 220, and a second sub-set (212_2) of communication paths 212 associated with a second sub-set (220_2) of antenna ports 220, wherein the communication path or paths 212_1 of the first sub-set of the communication paths 212 are different than the communication path or paths 212_2 of the second sub-set of the communication paths 212 because phase control and amplification circuitry 300_1 that is present in the communication path or paths 212_1 of the first sub-set of communication paths 212 is absent from the communication path or paths 212_2 of the second sub-set of communication paths 212.

There are multiple hybrid antenna modules 200_A, 200_B that comprise at least one active antenna 210_1 with local (on-antenna-module) phase control and amplification circuitry 300_1 and at least one passive antenna 210_2 without local (on-antenna-module) phase control and amplification circuitry 300_2.

The antenna module interface (to antenna module 200_A) at the transceiver module 100 comprises port 120_1A, port 120_2A. The transceiver module interface of the antenna module 200_A comprises antenna port 220_1, antenna port 220_2. Interconnect 2_1A interconnects the port 120_1A with the antenna port 220_1 of the antenna module 200_A. Interconnect 2_2A interconnects the port 120_2A with the antenna port 220_2 of the antenna module 200_A.

The antenna module interface (to antenna module 200_B) at the transceiver module 100 comprises port 120_1B, port 120_2B. The transceiver module interface of the antenna module 200_B comprises antenna port 220_1, antenna port 220_2. Interconnect 2_1B interconnects the port 120_1B with the antenna port 220_1 of the antenna module 200_B. Interconnect 2_2B interconnects the port 120_2B with the antenna port 220_2 of the antenna module 200_B.

The antenna module interface (to antenna module 200_A) at the transceiver module 100 has the same common configuration (the same number and order of ports 120), in this example, as the antenna module interface (to antenna module 200_B).

The transceiver module interface of antenna module 200_A has the same common configuration (the same number and ordered sequence of ports 220), in this example, as the transceiver module interface of antenna module 200_B.

Thus the antenna modules 200 are interchangeable.

It will be appreciated that there is a one-to-one mapping between antenna 210_i, communication path 212_i, antenna port 220_i, transceiver port 120_i. The mapping between transceiver path 112 and transceiver port 120 is one-to-one in this example. It should be appreciated that although in FIG. 2, there is a single active antenna 210_1 per antenna module 200 (and correspondingly a single (transceiver) port 120_1 in the first sub-set of (transceiver) ports 120, a single antenna port 220_1 in the first sub-set of antenna ports 220 and a single (antenna) communication path 212_1 in the first sub-set of (antenna) communication paths 212) in other examples there can be any number N_j of active antennas 210 per antenna module 200_j (and correspondingly N_j (transceiver) ports 120 in the first sub-set of (transceiver) ports 120, N_j antenna ports in the first sub-set of antenna ports 220 and N_j (antenna) communication paths in the first sub-set of (antenna) communication paths 212, where N_i>1.

It should be appreciated that although in FIG. 2, there is a single passive antenna 210_2 per antenna module 200 (and correspondingly a single (transceiver) port 120_2 in the second sub-set of (transceiver) ports 120, a single antenna port 220_2 in the second sub-set of antenna ports 220 and a single (antenna) communication path 212_2 in the second sub-set of (antenna) communication paths 212) in other examples there can be any number M_j of passive antennas 210 per antenna module 200_j (and correspondingly M_j (transceiver) ports in the second sub-set of (transceiver) ports 120, M_j antenna ports in the second sub-set of antenna ports 220 and M (antenna) communication paths in the second sub-set of (antenna) communication paths 212, where M_j>1.

The antenna modules 200_j can provide arrays of antennas 210 suitable for spatial multiplexing, beam-forming, spatial diversity. The transceiver module 100 can support, for example, one or more of: transmission spatial diversity, reception spatial diversity, spatial multiplexing, beam-forming, multiple-input multiple output, carrier aggregation, dual connectivity etc.

FIG. 3 illustrates an example of the system 10 previously described where there is not a one-to-one mapping between a transceiver path 112_i and (transceiver) port 120. The transceiver path 112_i is shared between multiple (transceiver) ports 120_ij for the same antenna port 220_i at different antenna modules 200_j.

The transceiver module 100 is configured to selectively couple a transceiver path 112_i to different antenna module interfaces (for different antenna modules 200_j).

In this example, but not necessarily all examples, the transceiver module is configured to selectively couple each transceiver path 112_i to multiple antenna module interfaces (for multiple antenna modules 200). In this example, but not necessarily all examples, the transceiver module is configured to selectively couple a transceiver path 112_i to every antenna module interface (for every antenna module 200_j). In this example, but not necessarily all examples, the transceiver module is configured to selectively couple each transceiver path 112_i to every antenna module interface (for every antenna module 200_j). In this example, but not necessarily all examples, the transceiver module is configured to selectively couple a (or each) transceiver path 112_i at the same (transceiver) port 120_ij/antenna port 220_ij of multiple antenna module interfaces for multiple antenna modules 200_j (or of every antenna module interface).

In the example illustrated there are multiple (two) antenna modules and each transceiver path 112_i is shared between multiple (transceiver) ports 120_ij for the same antenna port 220_i at each of the multiple antenna modules 200_j. The sharing can be performed using switching circuitry.

The transceiver path 112_1 is shared, by switching circuitry 130_1, between (transceiver) port 120_1A and port 120_1B. The port 120_1A is for antenna port 1 at antenna module 200_A. The port 120_1B is for antenna port 1 at antenna module 200_B. The transceiver path 112_2 is shared, by switching circuitry 130_2, between (transceiver) port 120_2A and port 120_2B. The port 120_2A is for antenna port 2 at antenna module 200_A. The port 120_2B is for antenna port 2 at antenna module 200_B. Each transceiver path 112_i is switched separately by switching circuitry 130_i In some examples, the switching circuitry 130_i is configured to couple a transceiver path 112_i to one (transceiver) port 120_ij.

In some examples, the switching circuitry 130_1 for a transceiver path 112_1 in the first sub-set of transceiver paths 112 that do not have phase control and amplification circuitry 300_1 is configured to couple that transceiver path 112_1 to one (transceiver) ports 120_1j. The switching circuitry 130_2 for a transceiver path 112_2 in the second sub-set of transceiver paths 112 that do have phase control and amplification circuitry 300_2 is configured to couple that transceiver path 112_2 to one (transceiver) port 120_2j. The transceiver module 100 can therefore use an active antenna 210_1 in one antenna module 200_j via the switching circuitry 130_1 in the first sub-set of transceiver paths 112 and switch in another passive antenna 210_2 as needed via the switching circuitry 130_2 in the second sub-set of transceiver paths 112_i.

Although there is now a selective one to many mapping between a transceiver path 112 and (transceiver) ports 120, there remains a one-to-one mapping between (transceiver) ports, antenna ports and (antenna) communication paths.

Each transceiver path 112_i is associated with multiple ports 120_ij e.g. the same antenna port 220_i at different antenna modules 200_j.

The transceiver module 100, selectively couples a transceiver path 112_1 of the first sub-set, with ports 120_1j for active antennas 210_1 at (e.g. all of the) antenna modules e.g. 200_j

The transceiver module 100, selectively couples a transceiver path 112_2 of the second sub-set, with ports 120_2j for passive antennas 210_2 at (e.g. all of the) antenna modules e.g. 200_j

In this example there is a single transceiver path 112_1 in the first sub-set of transceiver paths, which do not comprise phase control and amplification circuitry 300_1 and this single transceiver path 112_1 is switched to one (or, optionally, more) of multiple (transceiver) ports 120_1j which are for the same antenna port 220_i at different antenna modules 200_j.

In this example there is a transceiver path 112_2 in the second sub-set of transceiver paths, which do comprise phase control and amplification circuitry 300_2 and this transceiver path 112_2 is selectively switched to one of multiple (transceiver) ports 120_1j which are for the same antenna port 220_i at different antenna modules 200_j.

The transceiver module 100 can simultaneously operate any combination of the coupled antenna modules 200. The transceiver module 100 can use different combinations and permutations of antennas 210 at the different antenna modules 200.

The transceiver module 100 can select between antenna modules 200.

The transceiver module 100 can select the antennas used at a selected antenna module 200.

The transceiver module 100 can preferentially use active antennas.

The transceiver module 100 can add-in passive antennas to improve gain. The transceiver module 100 can add-in passive antennas at the same or at a different antenna module 200.

The system 10 has a significant performance gain, and only a modest cost increase, compared to a system that uses only passive antennas in antenna modules. The system 10 has a significant cost gain with only a modest performance impact compared to a system that uses only active antennas in antenna modules.

FIG. 4 illustrates an example of phase control and amplification circuitry 300. The phase control and amplification circuitry 300 has circuitry for controlling a phase of a signal and circuitry for controlling amplification of a signal.

Phase control and amplification circuitry 300 can be configured to provide phase and amplification control of a signal for transmission (e.g. an uplink signal) and/or to provide phase and amplification control of a received signal (e.g. a downlink signal). The illustrated phase control and amplification circuitry 300 is configured to provide phase and amplification control of a signal for transmission (e.g. an uplink signal) and to provide phase and amplification control of a received signal (e.g. a downlink signal).

In the transmission direction (left-to-right) a signal passes through a phase controller 302 and an amplifier 304. The amplifier is a power amplifier. The transceiver module 100 can control the phase controller 302 and the amplifier 304 to adjust the phase and amplitude of the signal for transmission. In the reception direction (right-to-left) a signal passes through an amplifier 306 and a phase controller 302. The amplifier is a low noise amplifier. The transceiver module 100 can control the phase controller 302 and the low noise amplifier 306 to adjust the phase and amplitude of the signal for reception.

The transmission path and the reception path can share the same phase controller 302. In other example embodiments it may be possible and needed to have separate phase control for transmission and reception. The requirements for amplification in the transmission path (power) and in the reception path (low noise) result in different amplifiers being used for the different paths. The circuitry 300 in this example therefore includes switches 308 that couple a common path through either the amplifier 304 of the transmission path or the amplifier 306 of the reception path. The phase controller 302 is in the common path.

The circuitry 300 can, for example, be configured to operate at radio frequencies, for example, frequencies over 1 GHz. The circuitry 300 can, for example, be configured to operate at radio frequencies over 6 GHz. The circuitry 300 is active, the amplifiers 304, 306 and the phase controller 302, and the switches 308 draw power. The circuitry 300 is active and provides dynamically controllable gain and dynamically controllable phase.

FIG. 5 illustrates an example of circuitry present within the transceiver circuitry 110. The transceiver circuitry 110 provides frequency conversion between lower frequency signals and higher frequency signals. The transceiver circuitry 110 is configured to provide circuitry for frequency up conversion of a signal for transmission (e.g. an uplink signal) and/or to provide circuitry for frequency down-conversion of a received signal (e.g. a downlink signal).

The illustrated transceiver circuitry 110 is configured to provide frequency up-conversion of a signal for transmission (e.g. an uplink signal) and to provide frequency down-conversion of a received signal (e.g. a downlink signal).

In the transmission direction (left-to-right) a signal passes through a frequency up-converter. The transceiver module 100 can control the frequency of the signal produced. In the reception direction (right-to-left) a signal passes through a frequency down-converter. The transceiver module 100 can control the frequency of the signal produced.

In this example, but not necessarily all examples, the circuitry 110 comprises switches 152 that couple a common path through either the frequency up converter or the frequency down-converter.

The frequency converters, in this example, have a superheterodyne configuration. For frequency up-conversion, a controllable reference signal is produced by a local oscillator 166 and is mixed at mixer 162 with the signal for transmission provided by circuitry 150 via switch 152. A high-pass filter (not illustrated) accepts the higher frequency mix and it is amplified by amplifier 164.

For frequency down-conversion, a controllable reference signal is produced by a local oscillator 176 and is mixed at mixer 172 with the received signal, after amplification by amplifier 174. In other embodiments the local oscillator is the same circuitry and provides signals suitable for up conversion or down conversion at the respective mixers. A low-pass filter (not illustrated) accepts the lower frequency mix which is coupled to circuitry 150, by switch 152, for further processing.

In this example, the transceiver circuitry 110 is coupled to multiple transceiver paths 112_i via multiple respective ports 182_i. Each transceiver path 112_i is coupled to one port 182_i.

The transceiver circuitry 110 illustrated is configured for time-divided half-duplex operation. The reception and the transmission are not simultaneous (half-duplex) and are separated in time (time-divided). Other configurations are possible such as full duplex, frequency divided communication where reception and the transmission are simultaneous (full-duplex) and are separated in frequency (frequency-divided).

The transceiver circuitry 110 illustrated is configured to be used for multiple transceiver paths 112. This is suitable for multiple-input multiple-output operation where the same frequency is used at different antennas 210. In other examples, transceiver circuitry 110 can be used for each transceiver path 112, so that the transceiver paths can operate at different frequencies. This is suitable for carrier aggregation where the different frequencies are used at different antennas 210.

The reception signal, received by the transceiver circuitry 110, can, for example, be at radio frequencies, for example, frequencies over 1 GHz, for example, over 6 GHz. The signal for transmission, provided by the transceiver circuitry 110, can, for example, be at radio frequencies, for example, frequencies over 1 GHz, for example, over 6 GHz. The interconnects 2 can therefore be configured to carry radio frequencies, for example, frequencies over 1 GHz, for example, over 6 GHz.

FIG. 6 illustrates an example of the system 10 previously described. It is similar to the example illustrated in FIG. 3 and similar references are used. In this example there are three antenna modules 200_A, 200_B, 200_C. Each antenna modules has the same transceiver module interface comprising four, ordered antenna ports 220_1, 220_2, 220_3, 220_4. Each antenna port 220_1 is for an active antenna 210_1, and the communication path 212_1 to the antenna 210_1 comprises phase control and amplification circuitry 300_1. Each antenna port 220_2, 220_3, 220_4 is for a respective passive antenna 210_2, 210_3, 210_4 and the antenna communication paths 212_2, 212_3, 212_4 for those antennas 210_2, 210_3, 210_4 do not comprise phase control and amplification circuitry.

In this example the transceiver module 100 has an identical antenna module interface for interconnection to each of the antenna modules 200_j. In this example there are three antenna module interfaces and three antenna modules 200_A, 200_B, 200_C. Each antenna module interface, for antenna module 200_j, comprises four, ordered (transceiver) ports 120_1j, 120_2j, 120_3j, 120_4j.

Each of the four, ordered (transceiver) ports 120_1A, 120_2A, 120_3A, 120_4A of the antenna module interface for antenna module 200_A is connected in order, via an interconnect (not illustrated) to each of the four, ordered antenna ports 220_1, 220_2, 220_3, 220_4 of the transceiver module interface of antenna module 200_A. Thus, transceiver port 120_iA interconnects to antenna port 220_i of the antenna module 200_A. Each of the four, ordered (transceiver) ports 120_1B, 120_2B, 120_3B, 120_4B of the antenna module interface for antenna module 200_B is connected in order, via an interconnect (not illustrated) to each of the four, ordered antenna ports 220_1, 220_2, 220_3, 220_4 of the transceiver module interface of antenna module 200_B. Thus, transceiver port 120_iB interconnects to antenna port 220_i of the antenna module 200_B. Each of the four, ordered (transceiver) ports 120_1C, 120_2C, 120_3C, 120_4C of the antenna module interface for antenna module 200_C is connected in order, via an interconnect (not illustrated) to each of the four, ordered antenna ports 220_1, 220_2, 220_3, 220_4 of the transceiver module interface of antenna module 200_C. Thus, transceiver port 120_iC interconnects to antenna port 220_i of the antenna module 200_C.

The transceiver module 100 comprises transceiver circuitry 110 and transceiver paths 112 extending between the transceiver circuitry 110 and ports 120. There is a shared transceiver path 112_i for each antenna port 220_i that is shared across the antenna modules 200_j.

The shared transceiver path 112_i is switched by switching circuitry 130_i towards antenna port 220_i for one or more antenna modules 200_j. The switching circuitry 130_i provides the (transceiver) port 120_ij for each antenna module j.

The antenna module interface to the antenna module 200_A couples a port 120_iA (i=1, 2, 3, 4) from each of the switching circuitry 130_i via routing that is not illustrated for clarity. The antenna module interface to the antenna module 200_B couples a port 120_iB (i=1, 2, 3, 4) from each of the switching circuitry 130_i via routing that is not illustrated for clarity. The antenna module interface to the antenna module 200_C couples a port 120_iC (i=1, 2, 3, 4) from each of the switching circuitry 130_i via routing that is not illustrated for clarity.

The first sub-set of the transceiver paths 112 includes the transceiver path 112_1 (only). The transceiver path 112_1 does not include phase control and amplification circuitry 300. The second sub-set of the transceiver paths 112 includes the transceiver paths 112_2, 112_3, 112_4 (only). Each of the transceiver paths 112_2, 112_3, 112_4 include phase control and amplification circuitry 300.

The transceiver module 100 can therefore use an active antenna 210_1 in one of different antenna modules 200_j via the switching circuitry 130_1 in the first sub-set of transceiver paths 112 and switch in other passive antennas 210_2, 210_3, 210_4 as needed, at the different antenna modules 200_j, via the switching circuitry 130_2, 130_3, 130_4 in the second sub-set of transceiver paths 112_2, 112_3, 112_4.

FIG. 7A illustrates an antenna module 200 as illustrated in FIG. 6. In some implementations it may be desirable to use antenna modules that have a different ordering of antenna ports 220 at a transceiver module interface. This can be accommodated either via interconnects between the transceiver module 100 and the antenna module 200 or by re-ordering the (transceiver) ports at an antenna module interface of the transceiver module 100. As illustrated in FIG. 7B, in some examples, the order of antenna ports in a transceiver module interface of an antenna module can be reversed.

FIG. 8 illustrates an example of a personal radio communication device 400. In this example it is a hand-portable device, for example a user equipment, that comprises the system 10 comprising transceiver module 100 and multiple antenna modules 200_A, 200_B, 200_C. In this example, the antenna modules 200_A, 200_B, 200_C are positioned and arranged to reduce the likelihood of interference when a user holds the device. The antenna modules are positioned near edges. In this and other examples, an antenna module 200 can comprise dual polarized antennas.

The antenna modules 200 are as previously described. In this example, the antenna modules are “semi-passive” antenna modules with only one antenna 210 connected directly to local on-antenna-module phase control and amplification circuitry 300. The other antennas 210 of the antenna module are passive.

The device 400 has multi-panel (multiple antenna modules 200) and minimal performance degradation while reducing the bill of materials cost.

The transceiver module 100 can use an active antenna in a module 200_A, 200_B, 200_C and switch in other passive antennas as needed.

The above-described examples find application as enabling components of:
automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, medical devices, GPS devices and other types of electronic systems, can readily employ examples of the present disclosure. Furthermore, devices can readily employ examples of the present disclosure regardless of their intent to provide mobility.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to ‘comprising only one . . . ’ or by using ‘consisting.’

In this description, the wording ‘connect’, ‘couple’ and ‘communication’ and their derivatives mean operationally connected/coupled/in communication. It should be appreciated that any number or combination of intervening components can exist (including no intervening components), i.e., to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database, or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’, or ‘may’ refers to a particular instance in a class of examples. A property of the instance can be a property of only that instance or a property of the class or a property of a sub-class of the class that includes some but not all the instances in the class. It is therefore implicitly disclosed that a feature described with reference to one example but not with reference to another example, can where possible be used in that other example as part of a working combination but does not necessarily have to be used in that other example.

As used herein, “at least one of the following:” and “at least one of” and similar wording, where the list of two or more elements are joined by “and” or “or” mean at least any one of the elements, or at least any two or more of the elements, or at least all the elements.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

The description of a feature, such as an apparatus or a component of an apparatus, configured to perform a function, or for performing a function, should additionally be considered to also disclose a method of performing that function. For example, description of an apparatus configured to perform one or more actions, or for performing one or more actions, should additionally be considered to disclose a method of performing those one or more actions with or without the apparatus.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance the Applicant may seek protection via the claims in respect of any patentable feature or combination of features hereinbefore referred to and/or shown in the drawings whether or not emphasis has been placed thereon.

1-21. (canceled)

22. A transceiver comprising:
transceiver circuitry;
ports for coupling to antennas;
transceiver paths extending between the transceiver circuitry and the ports, wherein a first sub-set of the transceiver paths is associated with a first sub-set of the ports and a second sub-set of the transceiver paths is associated with a second sub-set of the ports, wherein
the transceiver path or paths of the second sub-set of the transceiver paths is or are different from the transceiver path or paths of the first sub-set of the transceiver paths, wherein the difference is characterized in that phase control and amplification circuitry is present in the transceiver path or paths of the second sub-set of transceiver paths and is absent from the transceiver path or paths of the first sub-set of transceiver paths.

23. A transceiver as claimed in claim 22, comprising antenna module interfaces for coupling to respective antenna modules, each antenna module interface comprising at least one port for coupling to an antenna.

24. A transceiver as claimed in claim 23, wherein each antenna module interface comprises at least one port of the first sub-set for coupling to an antenna and at least one port of the second sub-set for coupling to an antenna.

25. A transceiver as claimed in claim 23, wherein each antenna module interface comprises the same number of ports and the same number of ports belonging to the first sub-set of ports and the same number of ports belonging to the second sub-set of ports.

26. A transceiver as claimed in claim 23, wherein a transceiver path is shared by multiple ports, wherein the multiple ports sharing the transceiver path are in different antenna module interfaces of the transceiver.

27. A transceiver as claimed in claim 23, wherein a switching circuitry is configured to share a transceiver path with one port in each antenna module interface of the transceiver.

28. A transceiver as claimed in claim 23, wherein each transceiver path has a respective switching circuitry configured to share the transceiver path with one port in each antenna module interface of the transceiver.

29. A transceiver as claimed in claim 28, wherein the switching circuitry in a transceiver path of the first sub-set of transceiver paths is configured to switch the transceiver path to one of multiple ports.

30. A transceiver as claimed in claim 28, wherein the switching circuitry in a transceiver path of the second sub-set of transceiver paths is configured to share the transceiver path with only one port at a time.

31. An antenna module comprising:
multiple antennas;
multiple antenna ports, each associated with an antenna;
a communication path between each respective antenna port and an antenna;
wherein a first sub-set of the communication path is associated with a first sub-set of antenna ports and a second sub-set of the communication path is associated with a second sub-set of the antenna ports, wherein the communication path or paths in the first sub-set of the communication path is or are different from the communication path or paths in the second sub-set of the communication path, wherein the difference is characterized in that phase control and amplification circuitry is present in the communication path or paths of the first sub-set of communication path and is absent from the communication path or paths of the second sub-set of communication path.

32. An antenna module as claimed in claim 31, wherein the first sub-set of the communication path includes only one communication path and the second sub-set of the communication path includes multiple communication paths.

33. An antenna module as claimed in claim 31, wherein each communication path in the first sub-set of the communication path enables an active antenna and each communication path in the second sub-set of the communication path enables a passive antenna.

34. A system comprising:
a transceiver comprising transceiver circuitry;
antenna modules comprising antennas;
interconnects, between the transceiver and antenna modules, completing communication paths between the transceiver circuitry and each antenna;
phase control and amplification circuitry associated with the communication paths, wherein, for a first sub-set of the communication paths, the phase control and amplification circuitry is located in antenna modules and, for a second, different, sub-set of the communication paths, the phase control and amplification circuitry is located in the transceiver.

35. A system as claimed in claim 34, wherein each antenna module comprises a transceiver module interface for interconnection with the transceiver and wherein the transceiver comprises an antenna module interface for each antenna module, for interconnection with the transceiver module interface of the antenna module.

36. A system as claimed in claim 35, wherein all transceiver module interfaces of the antenna modules have the same number and configuration of ports and all antenna module interfaces of the transceiver have the same number and configuration of ports, and wherein the number and configuration of ports in the antenna module interfaces correspond with the number and configuration of ports in the transceiver module interface for one-to-one connection.

37. A system as claimed in any of claim 35, wherein a switching circuitry is configured to share each transceiver path with one port in each antenna module interface to an antenna module.

38. A system as claimed in claim 34, wherein the transceiver module comprises:
transceiver paths extending between the transceiver circuitry and ports for coupling to antennas, wherein
a first sub-set of the transceiver paths is associated with a first sub-set of the ports and a second sub-set of the transceiver paths is associated with a second sub-set of the ports, wherein the transceiver path or paths of the second sub-set of the transceiver paths is or are different from the transceiver path or paths of the first sub-set of the transceiver paths, wherein the difference is characterized in that phase control and amplification circuitry is present in the transceiver path or paths of the second sub-set of transceiver paths and is absent from the transceiver path or paths of the first sub-set of transceiver paths.

39. A system as claimed in claim 38, wherein a switching circuitry in a transceiver path of the first sub-set of transceiver paths is configured to switch the transceiver path to one port of each antenna module interface to an antenna module and wherein the switching circuitry in a transceiver path of the second sub-set of transceiver paths is configured to switch the transceiver path to only one port at a time selected from one port in each antenna module interface.

40. A system as claimed in claim 39, wherein the switching circuitry in a transceiver path of the first sub-set of transceiver paths is configured to share the transceiver path with a port in each antenna module interface based on a position of that port in a sequence of ports at an antenna module interface.

41. A system as claimed in claim 34, wherein each antenna module comprises:
multiple antenna ports, each associated with an antenna;
a communication path between each respective antenna port and an antenna;
wherein a first sub-set of the communication path is associated with a first sub-set of antenna ports and a second sub-set of the communication path is associated with a second sub-set of the antenna ports, wherein the communication path or paths in the first sub-set of the communication path is or are different from the communication path or paths in the second sub-set of the communication path, wherein the difference is characterized in that phase control and amplification circuitry is present in the communication path or paths of the first sub-set of communication path and is absent from the communication path or paths of the second sub-set of communication path.
